(19) United States
(12) Patent Application Publication
(10) Pub. No.: US 2018/0046675 A1
(43) Pub. Date: Feb. 15, 2018

(54) AUTOMATIC ADJUSTMENT OF AN EXECUTION PLAN FOR A QUERY

(71) Applicant: SAP SE, Walldorf (DE)

(72) Inventors: XIAOMING ZHOU, Singapore (SG); Purva Prakash Joshi, Singapore (SG); Yan-Hong Huang, Singapore (SG)

(21) Appl. No.: 15/233,978

(22) Filed: Aug. 11, 2016

(51) Int. Cl. G06F 17/30

(52) U.S. Cl. CPC G06F 17/30469

(57) ABSTRACT

A DBMS optimizer generates a first query plan based on a first set of configuration parameters. The first query plan is executed in test mode one or more times. A first query object corresponding to the first query plan is created. The first query object includes the execution time of the first query plan.

When the optimizer determines a first query plan is generated, a second query plan is generated based on a second set of configuration parameters. The second query plan is executed in test mode one or more times. A second query object corresponding to the second query plan is created. The second query object includes the execution time of the second query plan.

Execution times of the first query plan and the second query plan are compared. The query plan with the shortest execution time is set as current query execution plan.

### FIELD

Embodiments described herein generally relate to computer systems designed to support analysis and consideration of different ways of processing a query.

### BACKGROUND

One of the challenges when upgrading a database management system (DBMS) is to avoid performance regression. In addition, a change in running environment or applications that are run can also cause performance regression. Performance of queries processed by the new DBMS version should be at least as good as performance of the same queries processed by the old DBMS version. Performance of queries depends on query execution plans. DBMSs include optimizers that determine query execution plans to be generated for the queries to be executed. Typically, an optimizer evaluates one or more possible query plans before selecting and generating an execution plan for a query. An estimated cost based on statistic data is assigned to the one or more possible query plans. For example, statistic data represent a resource footprint including required I/O operations, a CPU path length, disk buffer space, and disk storage service time.

However, in some cases statistic-based evaluation of possible query plans may not be precise. For example, restrictions such as inaccurate statistic data, limited compile resources, incorrect resource estimation, etc. may affect evaluation of the query plans, and thus the query performance may be damaged.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating architecture of system that generates and tests a query plan based on an older DBMS version and a query plan based on a newer DBMS version when upgrading the DBMS, according to one embodiment.

FIG. 2 is a block diagram illustrating architecture of system that automatically generates and tests a number of query plans based on one or more sets of configuration parameters, according to one embodiment.

FIG. 3 is a block diagram illustrating an architecture of a system that executes a query in accordance with a current query execution plan, according to one embodiment.

FIGS. 4A-D are flow diagrams illustrating a system process that determines a current query execution plan, according to one embodiment.

FIG. 5 is a flow diagram illustrating a system process that updates the execution time of a current query execution plan, according to one embodiment.

FIG. 6 is a block diagram of an exemplary computer system, according to one embodiment.

### DETAILED DESCRIPTION

Embodiments of techniques for in-memory auto query tuning are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A DBMS is capable of maintaining databases stored on hard disk drives (HDDs) and solid state drives (SSDs), as well as in-memory databases that are stored in the main memory. In-memory databases provide faster performance in comparison with disk-based databases due to reduced seek time when executing queries.

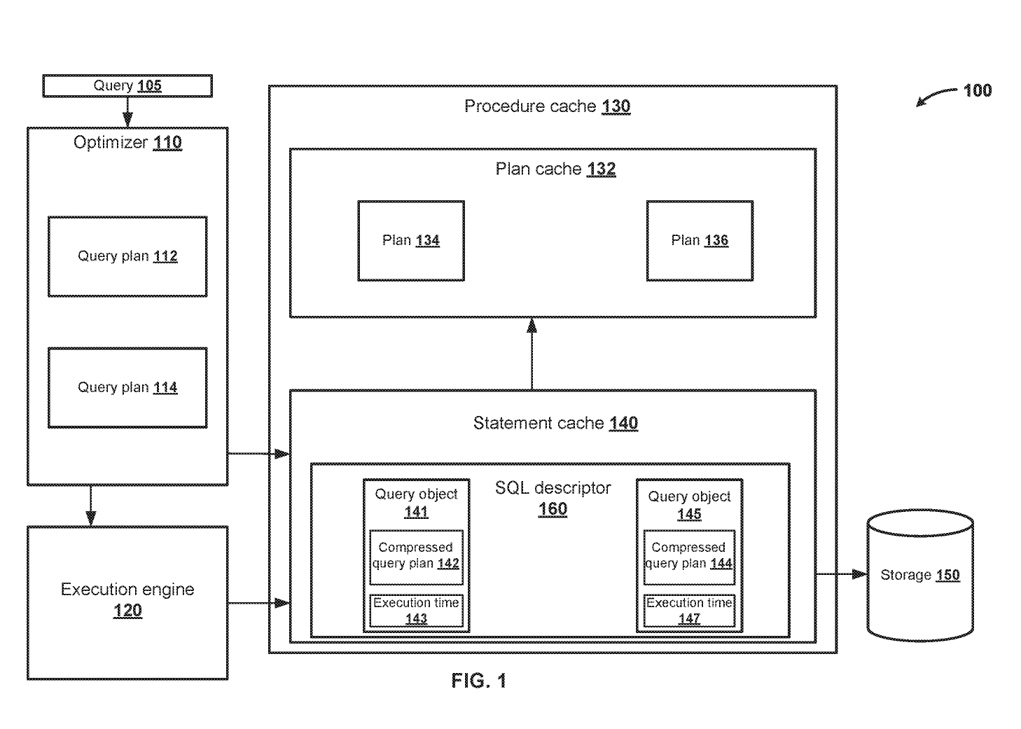

FIG. 1 is a block diagram illustrating architecture of system 100 that generates and tests a query plan based on an older DBMS version and a query plan based on a newer DBMS version when upgrading the DBMS, according to one embodiment. Query plans 112-114 are plans for execution of query 105. A query plan is an ordered set of steps to process data in a DBMS.

In one embodiment, optimizer 110 generates query plan 112 and query plan 114 for execution of query 105. Query plans 112-114 are data structures generated by optimizer 110. For example, each of query plans 112-114 may be a data structure that includes steps for execution of query 105. Optimizer 110 is configured to generate query plans such as query plan 112 and query plan 114 when a DBMS is upgraded from an older DBMS version (e.g., version 1.0) to a newer DBMS version (e.g., version 2.0). Optimizer 110 is part of the newer DBMS version. The query plans to be generated for the same query based on the older DBMS version (version 1.0) and the newer DBMS version (version 2.0).

In one embodiment, optimizer 110 generates query plan 112 based on the older DBMS version. Optimizer 110 loads configuration settings associated with the older DBMS version. The configuration settings include one or more configuration parameters. Setting a value of a configuration parameter to “on” or “off” enables or disables a feature of a DBMS. For example, optimizer 110 may load configuration settings of the older DBMS version from a generic storage, such as storage 150. The configuration settings of the older DBMS version may be stored in storage 150 prior to upgrade to the newer DBMS version.

In one embodiment, optimizer 110 evaluates a number of possible query plans before generating query plan 112. For example, optimizer 110 may automatically assign an estimated cost to each of the number of query plans by evaluating execution order of operators included in query 105 and various implementing algorithms for each operator. Based on the evaluation and the currently loaded configuration parameters of the older DBMS version, optimizer 110 determines a query plan with the lowest estimated cost from the number of query plans. The determined query plan (e.g., query plan 112) is generated by optimizer 110.

In one embodiment, optimizer 110 is configured to automatically execute query plan 112 in test mode. During the execution in test mode of query plan 112, execution time for query plan 112 is captured. Execution time of a query plan is the time for execution of query 105 in accordance with the corresponding query plan. In one embodiment, optimizer 110 may execute query plan 112 in test mode more than once. In this case, execution time of a query execution plan may be captured per single execution. An execution time parameter may be determined as an average of the values captured from the multiple query plan executions. The number of times a query plan is executed in test mode may be a configurable parameter, according to one embodiment. Upon each execution of query plan 112 in test mode, a value of a counter corresponding to query plan 112 is increased by one. This way, optimizer 110 determines whether test mode for the query plan is completed. For example, optimizer 110 may be configured to execute query plan 112 in test mode three times before calculating value of the execution time parameter of query plan 112.

In one embodiment, optimizer 110 executes query plan 112 in test mode through execution engine 120. Optimizer 110 sends query plan 112 to execution engine 120. Execution time of query plan 112 is captured during execution. Execution engine 120 executes queries by performing database functions necessary to process the query. The database functions include, but are not limited to, data dictionary management, data storage management, data transformation and presentation, security management, multiuser access control, backup and recovery management, data integrity management, database access languages and application programming interfaces, database communication interfaces, transaction management, updates, and logging.

In one embodiment, following the one or more executions of query 105 in accordance with query plan 112 (e.g., in accordance with the configured number of executions), optimizer 110 generates query plan 114. Query plan 114 is generated in accordance with the newer DBMS version. Query plan 114 is generated for execution of query 105. As mentioned above, optimizer 110 is part of the newer DBMS version. As such, configuration settings of the newer DBMS version are set in optimizer 110 when a database server that runs the newer DBMS version is started. Alternatively, the configuration settings of the newer DBMS version may be set by running a configuration command prior to generating query plan 114.

In one embodiment, identical to the process described above with reference to query plan 112, optimizer 110 evaluates a number of possible query plans before generating query plan 114. For example, optimizer 110 automatically assigns an estimated cost to each of the number of query plans by evaluating execution order of operators included in query 105 and various implementing algorithms for each operator. Based on the evaluation and the current configuration settings of the newer DBMS version, optimizer 110 determines a query plan with the lowest estimated cost from the number of query plans. Optimizer 110 generates the determined query plan (e.g., query plan 114). It should be recognized, however, that evaluation of query plans may be performed based on various query processing metrics. The query processing metrics include, but are not limited to, Central Processing Unit (CPU) time, logical input/output (I/O) time, physical input/output (I/O) time.

Optimizer 110 compares query plan 112 and query plan 114. When query plan 114 is different from query plan 112, optimizer 110 automatically executes query plan 114 in test mode one or more times. During the execution in test mode, execution time for query plan 114 is captured. When query plan 114 is executed in test mode more than once, execution time of query plan 114 is determined as an average of the values captured from the multiple query plan executions.

In one embodiment, upon execution in test mode of each of query plans 112-114, a query object corresponding to each query plan is created in statement cache 140. Statement cache 140 stores query objects previously generated for executed queries. This way, generation of query plans for incoming queries that match a previously cached query is avoided. Statement cache 140 allocates and consumes a portion of memory from procedure cache 130. Procedure cache 130 is a portion of main memory dedicated for storing objects for running queries, including query plans.

In one embodiment, the created query objects are associated with the generated query plans 112-114. Each query object includes a corresponding query plan from the query plans generated by optimizer 110. The query objects may be generated for one query (query 105). The number of query objects for query 105 are stored separately from the query objects for other queries. For example, a number of query objects generated for a Structured Query Language (SQL) query may be stored in SQL descriptor 160 document associated with the SQL query inside statement cache 140.

In one embodiment, a query object includes a corresponding query plan, as well as execution time parameter of the corresponding query plan. The query object stores the corresponding query plan and the execution time in a text form memory structure. In one embodiment, query object 141 includes compressed query plan 142 and execution time 143 parameter. Query object 141 is associated with query plan 112. Compressed query plan 142 corresponds to query plan 112. Compressed query plan 142 represents a simplified text form of the data structure of query plan 112, according to one embodiment. Execution time 143 parameter includes calculated execution time of query plan 112 from one or more executions of query plan 112 in test mode. Similarly, query object 145 includes compressed query plan 144 and execution time 147 parameter. Query object 145 is associated with query plan 114. Compressed query plan 144 corresponds to query plan 114. Compressed query plan 144 represents a simplified text form of the data structure of query plan 114. Execution time 147 parameter represents calculated execution time from one or more executions in test mode of query plan 114.

Further, procedure cache 130 includes plan cache 132. Plan cache 132 is configured to store one or more execution instances of query plans 112-114. Query plans 112-114 are stored in a simplified text form in corresponding query objects in statement cache 140. For example, when query plan 112 and query plan 114 are executed, plan 134 and plan 136 are created. Plan 134 and plan 136 are execution instances of query plan 112 and query plan 114, respectively.

In one embodiment, optimizer 110 compares values of execution times parameters of query plans 112-114 to determine a current execution query plan. Because query processing is performed in-memory, optimizer 110 generates multiple query plans and executes the query plans in test mode without substantial impact on query execution performance. Optimizer 110 compares values of execution time parameters from a real time execution of query plans 112-114 in test mode. The query plan with the smallest value for the execution time parameter is selected as current. For example, execution time 143 parameter of query plan 112 may have value “50 ms” and execution time 147 parameter of query plan 114 may have value “100 ms”. Therefore, upon comparison of execution time parameters 143 and 147 (50 ms<100 ms), optimizer 110 selects query plan 112 as a current query execution plan. In one embodiment, the selected current query execution plan is marked. For example, a flag value may be set to “1” in order to mark that the query plan is selected as current query execution plan.

By comparing query plans generated based on an older version and a newer version of a DBMS, performance regression when upgrading the DBMS may be prevented.

In one embodiment, compressed query plans 142-144 are stored in procedure cache 130. The current query execution plan (e.g., query plan 112) is provided for execution of query 105 on subsequent requests for execution of query 105. When a current query execution plan is selected, the current query execution plan is stored in storage 150. This way, when a DBMS server is started, the current query execution plan can be loaded into main memory from storage 150. In various embodiments, storage 150 may be a disc based storage device, flash memory storage device or another type of storage device utilizing non-volatile memory.

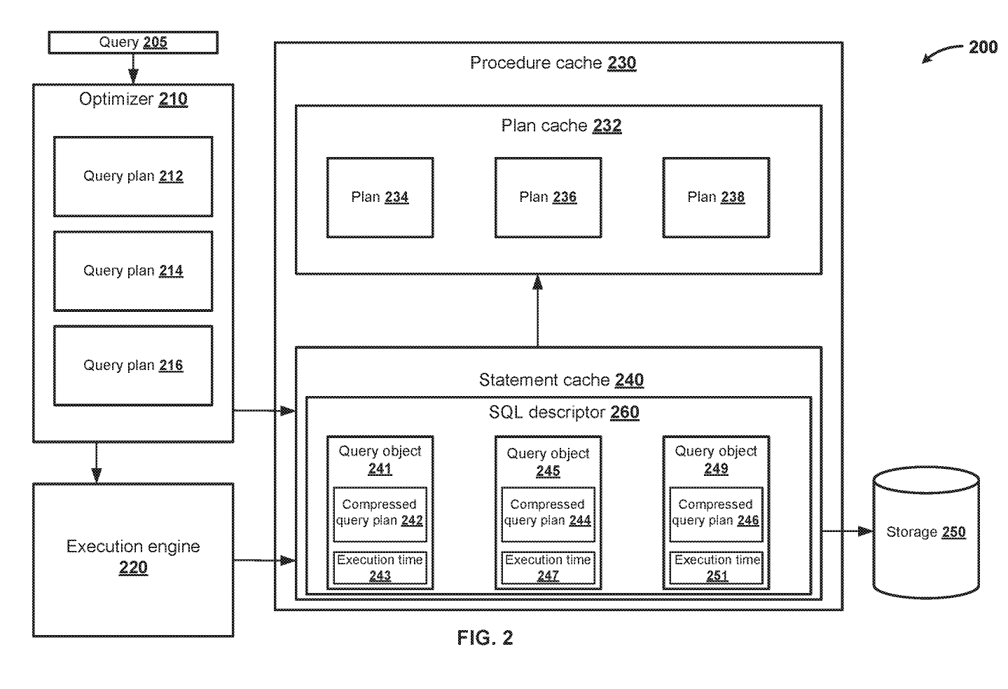

FIG. 2 is a block diagram illustrating architecture of system 200 that automatically generates and tests a number of query plans based on one or more sets of configuration parameters, according to one embodiment.

In one embodiment, optimizer 210 is configured to generate one or more customized query plans. That is, optimizer 210 generates query plans by enabling/disabling one or more functionalities of a current DBMS version. For example, function “merge joins” may be disabled. In such case, optimizer 210 will generate query plans that do not utilize the specified function (e.g., “merge joins). Similarly, a number of functionalities of the DBMS version may be enabled or disabled. This way, a different DBMS version can be simulated. By disabling one or more functionalities of the DBMS system, a prior DBMS version may be simulated. Additionally, by enabling/disabling one or more functionalities of the DBMS version, various scenarios can be simulated. An example of such scenario is favoring a specific application that relies on data managed by the DBMS by enabling/disabling one or more functionalities of the DBMS.

In one embodiment, optimizer 210 is configured to disable a function of the DBMS (e.g., “merge joins”) when generating query plan 212. Optimizer 210 is further configured to enable the “merge joins” function when generating query plan 214. For example, a configuration parameter “optgoal” may be set to “merge joins on” for the generation of query plan 214 and the same configuration parameter “optgoal” may be set to “merge joins off” for the generation of query plan 212. The DBMS may include one or more configuration parameters such as “optgoal”. For example, an additional configuration parameter, “optlevel”, may be defined to provide more flexibility when configuring optimizer 210. In one embodiment, the configuration parameter “optlevel” enables a different DBMS function for the generation of query plan 216. Configuration parameters for the DBMS may be preconfigured in optimizer 210, according to one embodiment. In one embodiment, a user and/or a program may customize the configuration parameters. In one embodiment, configuration parameters may be disabled by default and enabled when an upgrade of a DBMS is performed.

In one embodiment, query plan 212 is generated based on a value of configuration parameter “optgoal”, as well as query plan 214 is generated based on a different value of the configuration parameter “optgoal”. Query plan 216 is generated based on a value of the configuration parameter “optlevel”. It should be appreciated, however, that optimizer 210 may be configured to generate query plans based on multiple customized configurations of “optgoal” and “optlevel”, as well as based on values of other configuration parameters in addition to “optgoal” and “optlevel”. Further, optimizer 210 may be configured to generate query plans based on various customizations of configuration parameters by users and/or programs that enable or disable one or more features of a DBMS version.

In one embodiment, optimizer 210 evaluates a number of possible query plans before generating query plan 212. For example, optimizer 210 may automatically assign an estimated cost to each of the number of query plans by evaluating execution order of operators included in query 205 and various implementing algorithms for each operator. Based on the evaluation and the currently loaded set of configuration parameters, optimizer 210 determines a query plan with the lowest cost from the number of query plans. The determined query plan (e.g., query plan 212) is generated by optimizer 210. Similarly, optimizer 210 evaluates a number of possible query plans and configuration parameters prior to generation of both query plan 214 and query plan 216.

In one embodiment, optimizer 210 is configured to automatically execute query plan 212 in test mode. During the execution in test mode of query plan 212, execution engine 220 captures execution time for query plan 212. Execution time of a query plan is the time for execution of query 205 in accordance with the corresponding query plan. In one embodiment, optimizer 210 may execute query plan 212 in test mode more than once. In this case, execution time of a query plan may be captured per single execution. Value of an execution time parameter may be determined as an average of the values captured from the multiple query plan executions. The number of times a query plan is executed in test mode may be a configurable parameter, according to one embodiment. For example, optimizer 210 may be configured to execute query plans in test mode three times before calculating the execution time of query plan 212. Upon each execution of a query plan in test mode, a value of a counter is increased by one. This way, optimizer 210 determines whether test mode for the query plan is completed. For example, when optimizer 210 is configured to execute each query plan in test mode three times, the test mode for the query plan is completed when the value of the execution counter is “3”.

In one embodiment, upon generation of query plan 212, optimizer 210 executes query plan 212 in test mode through execution engine 220. Optimizer 210 sends query plan 212 to execution engine 220. Execution engine 220 executes queries by performing database functions necessary to process the query and captures execution times. The database functions include, but are not limited to, data dictionary management, data storage management, data transformation and presentation, security management, multiuser access control, backup and recovery management, data integrity management, database access languages and application programming interfaces, database communication interfaces, transaction management, updates, and logging.

In one embodiment, upon execution of each of query plans 212-216, a query object corresponding to each query plan is created in statement cache 240. Statement cache 240 stores query objects previously generated for executed queries. This way, generation of query plans for incoming queries that match a previously cached query is avoided. Statement cache 240 allocates and consumes a portion of memory from procedure cache 230. Procedure cache 230 is a portion of main memory dedicated to store objects for execution of queries, including query execution plans.

In one embodiment, the created query objects are associated with the generated query plans. Each query object includes a corresponding query plan from the query plans. The query objects may be generated for one query (query 205). The query objects for query 205 are stored separately from the query objects for other queries. For example, a number of query objects generated for a Structured Query Language (SQL) query may be stored in SQL descriptor 260 document associated with the SQL query inside statement cache 240.

In one embodiment, a query object includes a corresponding query plan, as well as execution time parameter of the corresponding query plan. The query object stores the corresponding query plan and the execution time parameter in text form. In one embodiment, query object 241 includes compressed query plan 242 and execution time 243 parameter. Query object 241 is associated with query plan 212. Compressed query plan 242 represents a simplified text form of the data structure of query plan 212. Execution time 243 parameter includes calculated execution time of query plan 212 from one or more executions of query execution plan 212 in test mode. Similarly, query object 245 includes compressed query plan 244 and execution time 247 parameter; query object 249 includes compressed query plan 246 and execution time 251 parameter. Query object 245 is associated with query plan 214 and query object 249 is associated with query plan 216. Compressed query plan 244 and compressed query plan 246 represent simplified text forms of data structures of query plan 214 and query plan 216, respectively. Execution time 247 parameter and execution time 251 parameter represent calculated execution times from one or more executions in test mode of query plan 214 and query plan 216, respectively.

Further, procedure cache 230 includes plan cache 232. Plan cache 232 is configured to store one or more execution instances of query plans 212-216. Compressed query plans 242-246 are simplified text forms of query plans 212-216, respectively, stored in corresponding query objects in statement cache 240. For example, when query plan 212, query plan 214 and query plan 216 are executed, plan 234, plan 236 and plan 238 are created. Plan 234, plan 236 and plan 238 are execution instances of query plan 212, query plan 214 and query plan 216, respectively.

In one embodiment, optimizer 210 compares values of execution times parameters of query plans 212-216 to determine a current query execution plan. Because query processing is performed in-memory, optimizer 210 generates multiple query plans and executes the query plans in test mode without substantial impact on query execution performance. Optimizer 210 compares values of execution time parameters from a real time execution of query plans 212-216 in test mode. The query plan with the smallest value for the execution time parameter is selected as current. For example, execution time 243 parameter of query plan 212 may have value “50 ms”, execution time 247 parameter of query plan 214 may have value “100 ms”, and execution time 251 parameter of query plan 216 may have value “150 ms”. Therefore, upon comparison of execution time parameters 243, 247, and 251 (50 ms<100 ms<150 ms), optimizer 210 selects query plan 212 as a current query execution plan. In one embodiment, the selected current query execution plan is marked. For example, a flag value may be set to “1” in order to mark that the query plan is selected as current query execution plan.

In one embodiment, precise determination of a current query execution plan is possible due to the comparison between query plans that employ multiple functionalities of the DBMS. This way, various user scenarios can be simulated and the query plan with the smallest value for the execution time parameter across all simulated scenarios is selected as current query execution plan.

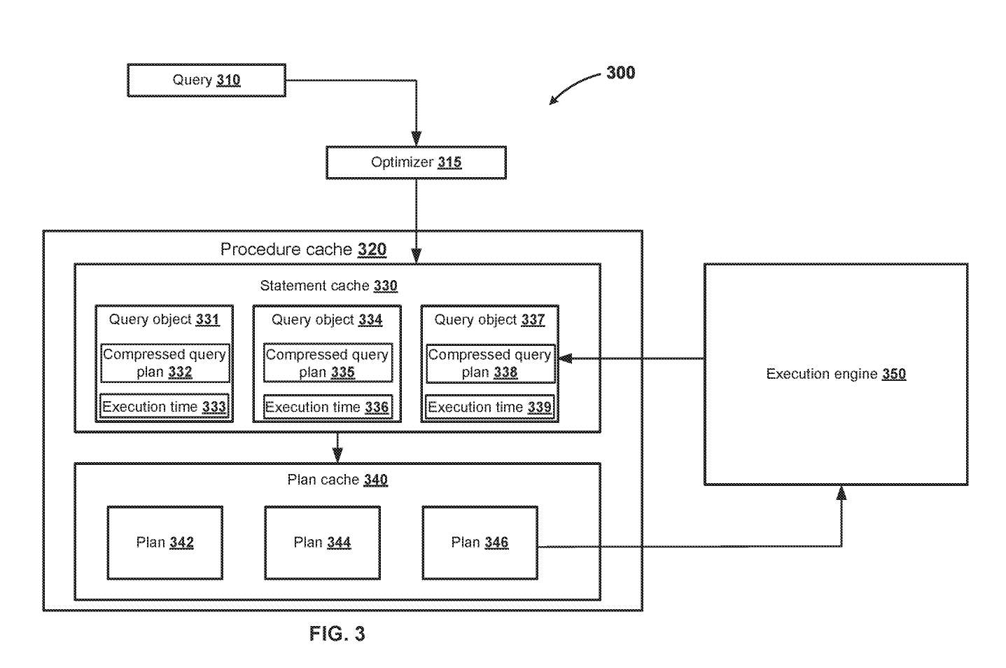

FIG. 3 is a block diagram illustrating an architecture system 300 that executes query 310 in accordance with a current query execution plan, according to one embodiment. When query 310 is processed, optimizer 315 searches in procedure cache 320 for a current query execution plan corresponding to query 310. For example, optimizer 315 may search in procedure cache 320 for a query plan that is marked as current query execution plan. Optimizer 315 is configured to process query 310 in accordance with the current query execution plan. In one embodiment, query plans for query 310 have already been generated and executed in test mode by optimizer 315. Thus, a number of query objects is created in statement cache 330. The number of query objects is associated with query 310.

Each object from the number of query objects includes a simplified version of a query plan data structure and corresponding execution time parameter of the query plan. For example, query object 331 includes compressed query plan 332 and execution time 333 parameter. Execution time 333 parameter value represents calculated time for execution of query 310 in accordance with a query plan associated with compressed query plan 332. Similarly, query object 334 includes compressed query plan 335 and execution time 336 parameter; query object 337 includes compressed query plan 338 and execution time 339 parameter. Values of execution time parameters 333-339 are calculated for each query plan associated with the corresponding compressed query plans 332-338, as described above with reference to FIG. 1. Further, based on execution time parameters, a current query execution plan for query 310 is selected. The current query execution plan represents a query plan that has the smallest value for the execution time parameter among the number of query objects associated with query 310. The number of query objects associated with query 310 store query plans generated for execution of query 310. For example, a query plan associated with compressed query plan 338 of query object 337 is marked as current query execution plan for query 310.

In one embodiment, each query plan has a corresponding one or more execution instances in plan cache 340. Plans 342, 344, and 346 are instances of query plans associated with compressed query plans 332, 335, and 338, respectively.

In one embodiment, optimizer 315 searches in statement cache 330 for a current query execution plan for query 310. Optimizer 315 determines that a query plan associated with compressed query plan 338 is marked as the current query execution plan. Therefore, optimizer 315 submits plan 346 (corresponding to the query plan associated with compressed query plan 338) to execution engine 350. Query 310 is executed in accordance with the determined current query execution plan by execution engine 350.

In one embodiment, during execution of query 310, execution engine 350 captures execution time of the query execution plan the query plan associated with compressed query plan 338). Average sum of the value of the captured execution time and the value of execution time 339 parameter is then calculated. Value of execution time 339 parameter is updated in accordance with the calculated average sum.

In one embodiment, upon updating the value of execution time 339 parameter, execution time parameters 333, 336, and 339 in query objects 331, 334, and 337, respectively, are compared. Based on the comparison, a new current query execution plan may be selected. For example, upon the update of the value of execution time 339 parameter, it is determined that execution time 333 parameter now has the smallest value compared to the values of execution time 336 parameter and execution time 339 parameter. Therefore, the query plan associated with compressed query plan 332 that corresponds to execution time 333 parameter is selected as a new query execution plan. The new query execution plan is set as the current query execution plan. In one embodiment, value of a flag of the query plan associated with compressed query plan 332 is set to “1” to mark the current query execution plan. Concurrently, value of a flag of the old current query execution plan is set to “0”. When a subsequent request to execute query 310 is received, plan 342 (that is an instance of the query plan associated with compressed query plan 332 in plan cache 340) will be submitted to execution engine 350. Query 310 will be executed in accordance with the current query execution plan.

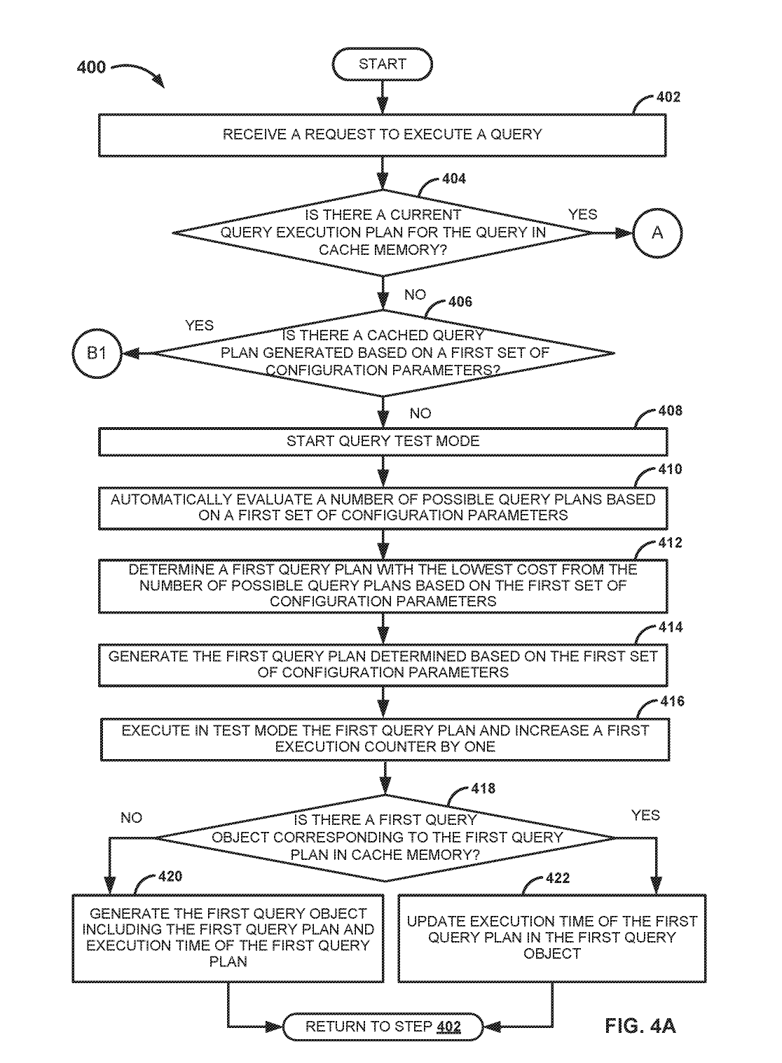

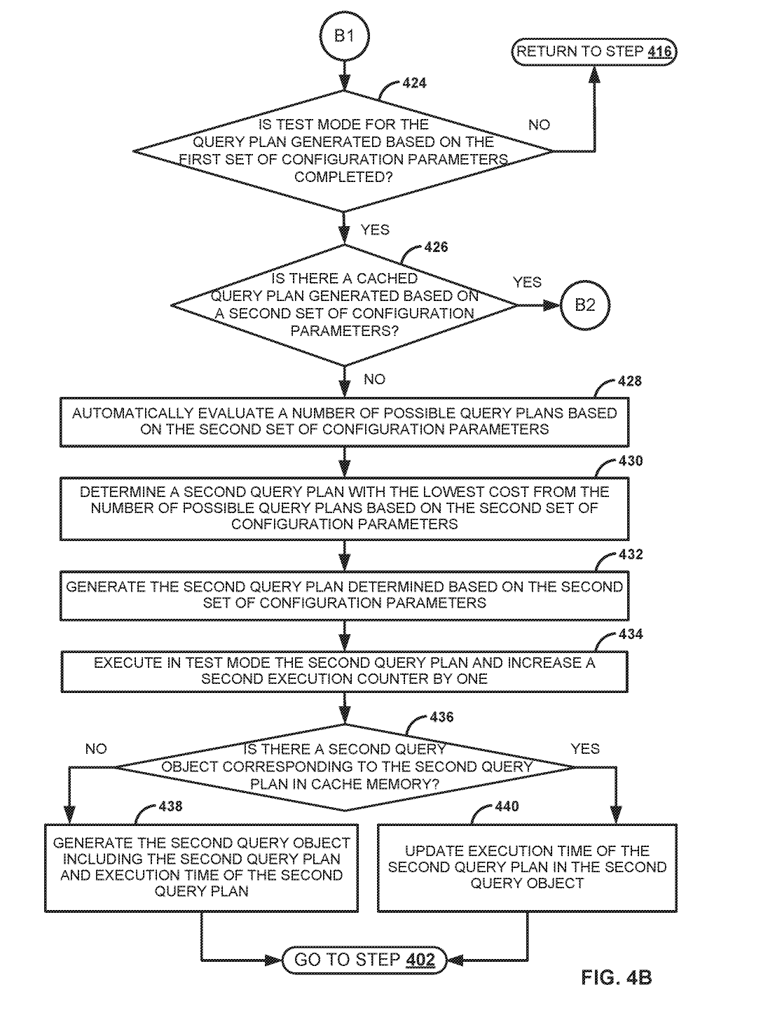

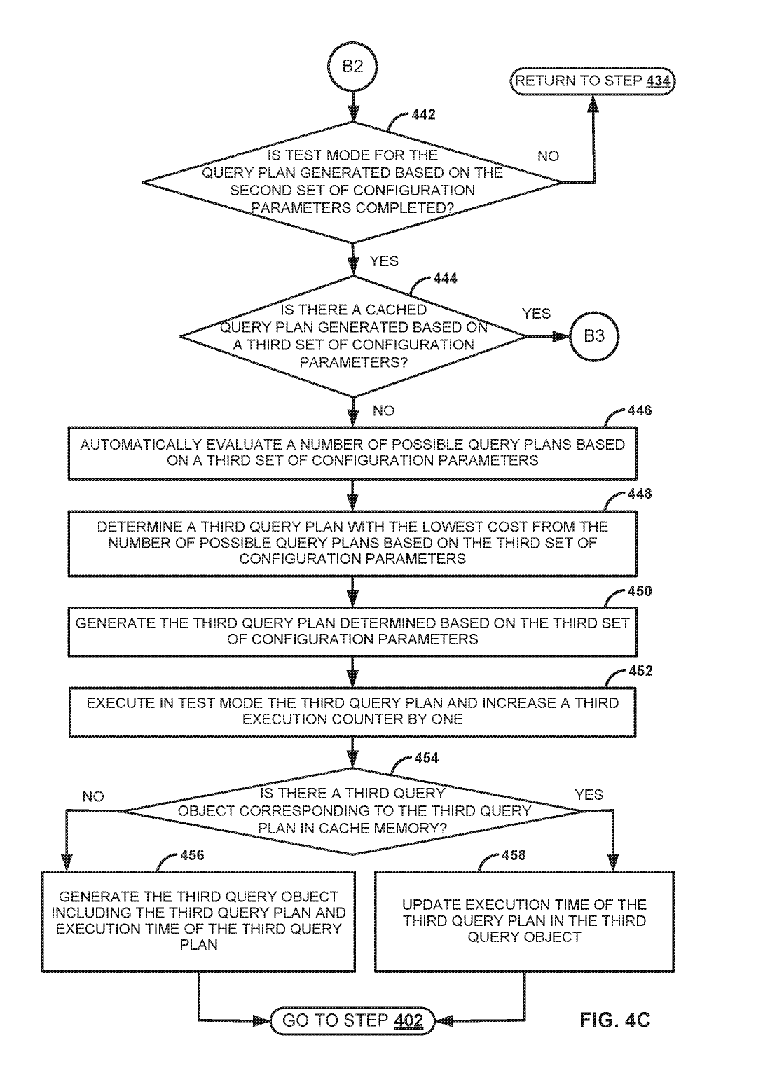

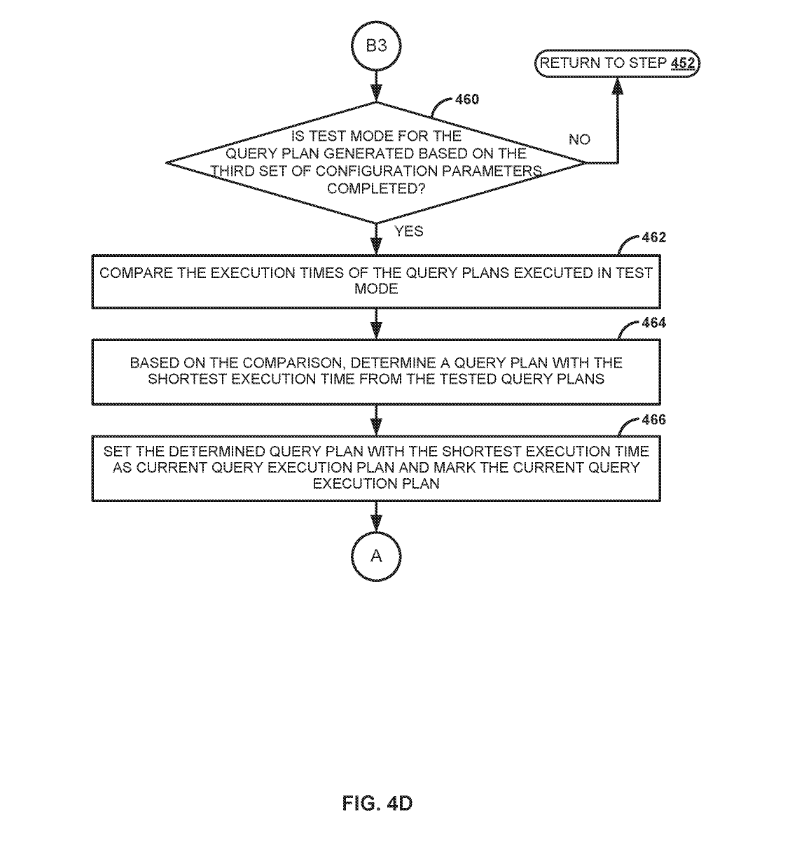

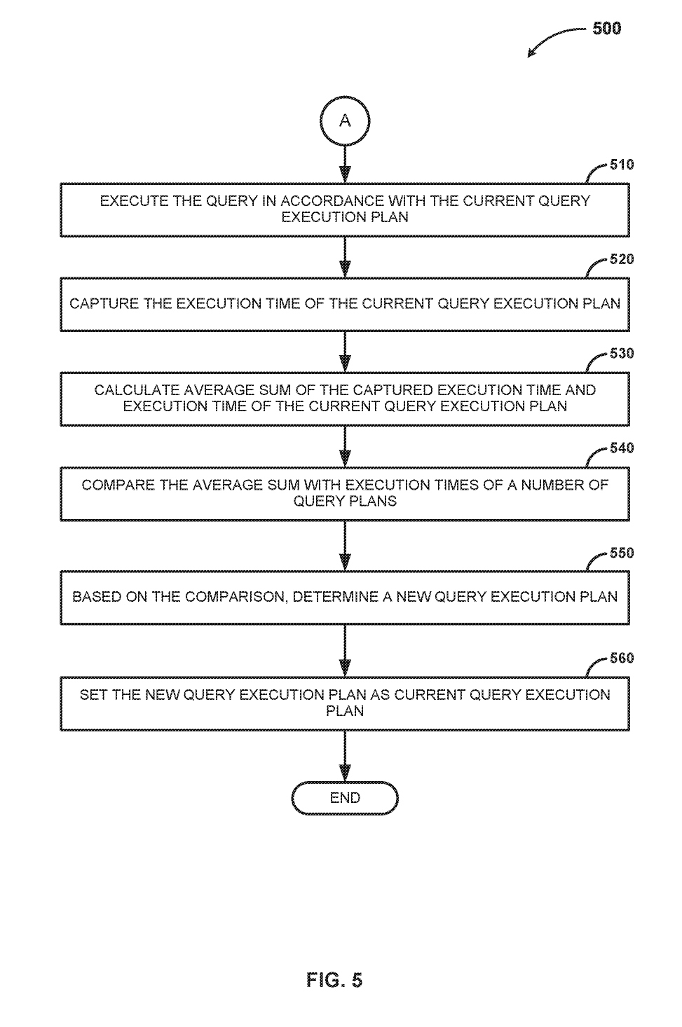

FIGS. 4A-D are flow diagrams illustrating a process 400 that determines a current query execution plan, according to one embodiment. Initially, at 402 (FIG. 4A), a request to execute a query is received. Execution of queries is managed by a DBMS. An optimizer of the DBMS is configured to select a current plan for execution of each query. At 404, it is checked whether a current query execution plan is present in cache memory. For example, a part of the cache memory that is dedicated for storing query plans (statement cache) is checked for a current query execution plan. In one embodiment, it is determined that there is a current query execution plan. Therefore, process A is initiated. Process A is described below with reference to FIG. 5.

When it is determined that there is not a current query execution plan, at 406, it is checked whether a query plan generated based on a first set of configuration parameters is cached. Upon determining that a query plan generated based on a first set of configuration parameters is not cached, at 408, the query test mode is started. In one embodiment, the query test mode is managed by the optimizer of the DBMS. At 410, the optimizer of the DBMS automatically evaluates a number of possible query plans based on a first set of configuration parameters. A query execution plan may not be present for a query if the query is executed for the first time since a DBMS server is started.

In one embodiment, the first set of configuration parameters may represent a configuration saved by an older DBMS version. For example, prior to upgrade to a newer DBMS version. Such set of older DBMS version may be saved for compatibility purposes such as simulating an optimizer of the older DBMS version. In one embodiment, the first set of configuration parameters may include customized configuration of a current DBMS version where one or more functions are disabled. For example, specific functions of a DBMS may be disabled in order to simulate various production scenarios such as favoring a specific application, etc.

Next, at 412, a query plan with the lowest cost from the number of possible query plans based on the first set of configuration parameters is determined. At 414, the determined first query plan is generated. For example, the optimizer of the DBMS generates the determined query plan based on the first set of configuration parameters.

Next, at 416, the generated first query plan is executed in test mode and a first execution counter is increased by one. In one embodiment, a value of an execution counter is increased by one at each execution of a query plan in test mode. During execution of the first query plan, execution time is captured. Upon execution of the first query plan in test mode, at 418, a check is performed to determine whether a first query object corresponding to the first query plan is present in cache memory.

In one embodiment, it is determined a first query object corresponding to the first query plan is not present in cache memory. Therefore, process 400 continues at 420 where the first query object is generated. The first query object corresponding to the first query plan. In one embodiment, the first query object includes the first query plan and the captured execution time of the first query plan.

In one embodiment, upon performing the check for the first query object, it is determined that the first query object corresponding to the first query plan is present in cache memory. Therefore, process 400 continues at 422 by updating execution time of the first query plan in the first query object. For example, value of an execution time parameter in the first query object may be updated by calculating average sum of the captured execution time during execution of the first query plan in test mode and the current value of the execution time parameter.

When it is determined that there is a query plan generated based on the first set of configuration parameters in cache memory, process 400 continues at 424 (FIG. 4B), where a check is performed to determine whether test mode for the query plan generated based on the first set of configuration parameters is completed. In one embodiment, the value of the first execution counter is checked to determine whether the test mode is completed. For example, the optimizer of the DBMS may be configured to execute query plan in test mode three times. Therefore, the optimizer of the DBMS may determine test mode is not completed for the query plan generated based on the first set of configuration parameters if the value of the first execution counter is smaller than “3”. In one embodiment, it is determined that the test mode for the query plan generated based on the first set of configuration parameters e.g., a first query plan) is not completed and, therefore, process 400 returns to step 416.

When it is determined that the test mode for first query plan is completed (value of the first execution counter is “3”), at 426, a further check is performed to determine whether a query plan generated based on a second set of configuration parameters (e.g., a second query plan) is present in cache memory. In one embodiment, it is determined that there is no second query plan in cache memory. Therefore, at 428, a number of possible query plans based on a second set of configuration parameters is automatically evaluated.

Next, at 430, a query plan with the lowest cost from the number of possible query plans based on the second set of configuration parameters is determined. At 432, the determined second query plan is generated. For example, the optimizer of the DBMS generates the determined query plan based on the second set of configuration parameters.

Next, at 434, the generated second query plan is executed in test mode and a second execution counter is increased by one. During execution of the second query plan, execution time is captured. Upon execution of the second query plan in test mode, at 436, a check is performed to determine whether a second query object corresponding to the second query plan is present in cache memory.

In one embodiment, it is determined a second query object corresponding to the second query plan is not present in cache memory. Therefore, process 400 continues at 438, where the second query object is generated and an execution counter is increased by one. The second query object corresponding to the second query plan. In one embodiment, the second query object includes the second query plan and the captured execution time of the second query plan.

In one embodiment, upon performing the check for the second query object, it is determined that the second query object corresponding to the second query plan is present in cache memory. Therefore, process 400 continues at 440 by updating execution time of the second query plan in the second query object. For example, value of an execution time parameter in the second query object may be updated by calculating average sum of the captured execution time during execution of the second query plan in test mode and the current value of the execution time parameter.

In one embodiment, upon performing a check at step 426, it is determined that a query plan generated based on the second set of configuration parameters is present. Therefore, at 442 (FIG. 4C) a check is performed to determine whether test mode for the query plan generated based on the second set of configuration parameters is completed. The value of the second execution counter is checked to determine whether the test mode is completed. In one embodiment, it is determined that the test mode for the query plan generated based on the second set of configuration parameters (e.g., a second query plan) is not completed and, therefore, process 400 returns to step 434.

When it is determined that the test mode for second query plan is completed (value of the second execution counter is “3”), at 444, a further check is performed to determine whether a query plan generated based on a third set of configuration parameters (e.g., a third query plan) is present in cache memory. In one embodiment, it is determined that there is no third query plan in cache memory. Therefore, at 446, a number of possible query plans based on a third set of configuration parameters is automatically evaluated.

Next, at 448, a query plan with the lowest cost from the number of possible query plans based on the third set of configuration parameters is determined. At 450, the determined third query plan is generated.

Next, at 452, the generated third query plan is executed in test mode and a third execution counter is increased by one. During execution of the third query plan, execution time is captured. Upon execution of the third query plan in test mode, at 454, a check is performed to determine whether a third query object corresponding to the third query plan is present in cache memory.

In one embodiment, it is determined a third query object corresponding to the third query plan is not present in cache memory. Therefore, process 400 continues at 456 where the third query object is generated and an execution counter is increased by one. The third query object corresponding to the third query plan. In one embodiment, the third query object includes the third query plan and the captured execution time of the third query plan.

In one embodiment, upon performing the check for the third query object, it is determined that the third query object corresponding to the third query plan is present in cache memory. Therefore, process 400 continues at 458 by updating execution time of the third query plan in the third query object. For example, value of an execution time parameter in the second query object may be updated by calculating average sum of the captured execution time during execution of the third query plan in test mode and the current value of the execution time parameter.

In one embodiment, it is determined that the third query plan is present in cache memory. Therefore, process 400 continues at 460 (FIG. 4D). A check is performed to determine whether the test mode for the third query plan is completed. In one embodiment, it is determined that the test mode for the third query plan is not completed and, therefore, process 400 returns at step 452.

When it is determined that the test mode for the third query plan is completed (value of the third execution counter is “3”), at 462, process 400 continues by comparing execution times from the first query object, the second query object, and the third query object. Based on the comparison, at 464, a query plan with the shortest execution time from the generated query plans is determined. The determined query plan with the shortest execution time is set, at 466, as current query execution plan. In one embodiment, a value of a flag is set to “1” to mark the current query execution plan. In one embodiment, upon determination of the current query execution plan, process A is initiated. Process A is described below with reference to FIG. 5.

Although FIGS. 4A-I) describe a process of executing once in test mode the generated query plans, it would be appreciated that the optimizer of the DBMS may be configured in a way that each of the generated query plans is executed in test mode multiple times. For example, a query may be executed three times in accordance with the first query plan, three times in accordance with the second query plan, and three times in accordance with the third query plan. This way, the query may have to be executed in total nine times in test mode before a current query execution plan is determined.

FIG. 5 is a flow diagram illustrating a process 500 that updates value of an execution time parameter of a current query execution plan, according to one embodiment. Process 500 starts when it is determined, at step 404 of process 400, that a current query execution plan is present for a query. Process 400 is described above with reference to FIGS. 4A-D.

In one embodiment, the current query execution plan is marked. For example, a value of a flag of the current query execution plan is set to “1” to mark the current query execution plan. Next, at 510, the query is executed in accordance with the current query execution plan. For example, a DBMS optimizer selects an execution instance of the current query execution plan from cache memory. The execution instance is submitted to an execution engine. During execution, at 520, execution time of the current query execution plan is captured. Upon execution of the query in accordance with the current query execution plan, at 530, an average sum of the value of the captured execution time and the value of the execution time parameter of the current query execution plan is calculated. The value of the execution time parameter of the current query execution plan is automatically calculated upon execution of the current query execution plan in test mode. Execution in test mode is part of process 400 that is described in details with reference to FIGS. 4A-D. Upon calculation of the average sum, value of the execution time parameter stored in a query object corresponding to the current query execution plan, is updated.

Next, at 540, the value of the updated execution time parameter of the current query execution plan is compared to values of execution time parameters of a number of query plans. Values of the execution time parameters of the number of query plans are calculated during execution of the number of query execution plans in test mode (FIGS. 4A-D, process 400). In one embodiment, upon execution of the number of query plans in test mode, a number of query objects corresponding to the number of query execution plans are stored in cache memory. Each query object stores a corresponding query plan, as well as an execution time parameter of the corresponding query plan.

Then, at 550, a new query execution plan is determined. The new query execution plan is selected based on the comparison between the updated value of the execution time parameter of the current query execution plan and values of the execution time parameters of the number of query plans. In one embodiment, the new query execution plan and the current query execution plan are one and the same query execution plan. For example, if the comparison determines that the updated value of the execution time parameter of the current query execution plan still has the smallest value when compared to the values of the execution time parameters of the number of query plans, the current query execution plan remains as current. However, when the comparison determines that value of execution time parameter of another query plan of the number of query plans has the smallest value among values of execution time parameters of the number of query execution plans, a new query execution plan is determined.

Process 500 ends at 560, where the new query execution plan is set as a current query execution plan.

In-memory auto query tuning prevents query performance regression when upgrading a database management system (DBMS). Upon receiving an initial request to execute a query, the DBMS searches volatile memory for a current query execution plan.

When a current query execution plan is not present, an optimizer of the DBMS evaluates a number of possible query plans for a set of configuration settings. Upon evaluation, a query plan with the lowest estimated cost from the number of evaluated possible query plan is determined. A query plan corresponding to the set of configuration settings is generated. Upon receiving consequential requests to execute the query, a number of query plans are generated based on a number of sets of configuration parameters. The number of query plans generated for execution of the same query. The optimizer is configured to simulate multiple versions of the DBMS and multiple scenarios by loading multiple sets of configuration settings.

Upon generation of the query plan, the DBMS optimizer executes the query plan in test mode. Optionally, the query plan can be executed in test mode multiple times. Execution time for each execution of query plan is captured. When the query plan is executed in test mode more than once, the execution time for this query plan is determined by calculating average sum of the captured execution times from each execution of the query plan.

A query object is created for each query plan from the number of query plans. The query object includes the corresponding query plan, as well as the execution time for the query plan. A current query execution plan is determined by comparing execution times of the number of query plans. The current query execution plan has the smallest value for execution time in comparison with the execution times of the number of query plans.

When a subsequent request to execute the query is received, the query is executed in accordance with the current query execution plan. During execution of the query, execution time is captured. Upon execution of the query, average sum of the value of the captured execution time and value of the execution time for the current query execution time from the query object corresponding to the current query execution plan is calculated. The average sum value is stored in the query object as execution time for the current execution plan.

Upon updating the execution time in the query object, execution times of the number of query plans are compared. Based on the comparison, a new query execution plan is determined. The new query execution plan is set as current query execution plan.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an Interpreter. For example, an embodiment may be implemented using Java. C++, or other object-oriented programming language and development tools. Another embodiment may be implemented in hard-wired circuitry in place of, or in combination with machine readable software instructions.

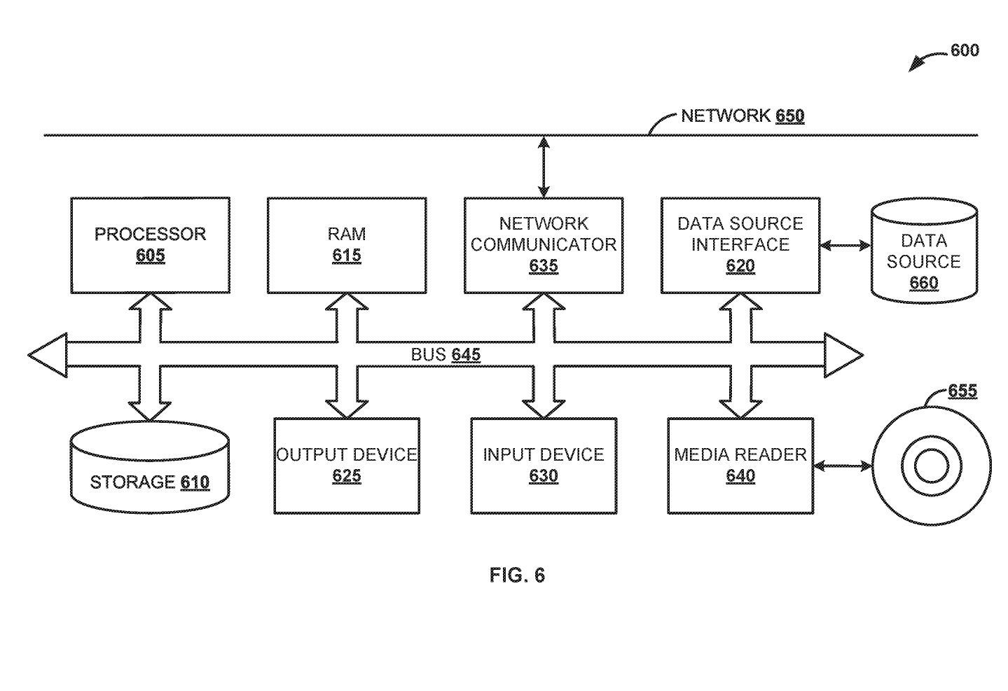

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 660. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim constriction.

What is claimed is:

1. A computer implemented method to prevent regression of query performance of a database management system (DBMS), the method comprising:
receiving a first request to execute a query;
determining that a first query plan generated based on a first set of configuration parameters is present;
generating a second query plan based on a second set of configuration parameters;
automatically calculating execution time of the second query plan;
creating a second query object corresponding to the second query plan, wherein the second query object comprises the second query plan and the calculated execution time of the second query plan;
comparing a calculated execution time of the first query plan with the calculated execution time of the second query plan; and
based on the compared execution times, determining a query plan with a shortest execution time from the first query plan and the second query plan; and
setting the determined query plan with the shortest execution time as a current query execution plan.

2. The method of claim 1 further comprising:
evaluating a number of possible query plans based on the first set of configuration parameters, wherein an estimated cost is assigned to each of the number of possible query plans;
determining a possible query plan with a lowest estimated cost from the number of possible query plans; and
generating the first query plan from the determined possible query plan.

3. The method of claim 1 further comprising:
receiving a second request to execute the query, wherein the second request is received before the first request;
checking if the first query plan is present and was generated based on the first set of configuration parameters;
upon determining the first query plan is not present, generating the first query plan;
automatically calculating the execution time of the first query plan by executing the first query plan in test mode; and
creating a first query object corresponding to the first query plan, wherein the first query object comprises the first query plan and the execution time of the first query plan.

4. The method of claim 1, wherein automatically calculating the execution time of the second query plan comprises:
executing the second query plan in test mode one or more times;
capture execution times from the one or more executions of the second query plan; and
calculate an average sum of the captured execution times of the second query plan.

5. The method of claim 1 further comprising:
receiving a third request to execute the query;
determining that the first query plan and the second query plan are present;
generating a third query plan based on a third set of configuration parameters;
automatically calculating execution time of the third query plan;
creating a third query object corresponding to the third query plan, wherein the third query object comprises the third query plan and the automatically calculated execution time of the third query plan;
comparing the calculated execution time of the third query plan with the calculated execution time of the first query plan and with the calculated execution time of the second query plan; and
based on the compared execution times, determining the current query execution plan.

6. The method of claim 5 further comprising:
executing the query in accordance with the current query execution plan, wherein execution time is captured;
calculating an average sum of the captured execution time and the calculated execution time of the current query execution plan;
comparing the calculated average sum with the execution times of the first query plan, the second query plan, and the third query plan to determine a new query execution plan with the shortest execution time; and
setting the new query execution plan as the current query execution plan.

7. The method of claim 5, wherein automatically calculating the execution time of the third query plan comprises:
executing the third query plan in test mode one or more times;
capturing execution times from the one or more executions of the third query plan; and
calculating an average sum of the captured execution times of the third query plan.

8. A computer system to prevent regression of query performance of a database, the system comprising:
a memory comprising computer executable instructions;
at least one computer processor coupled to the memory to execute the instructions to perform actions comprising:
receive a first request to execute a query;
determine that a first query plan generated based on a first set of configuration parameters is present;
generate a second query plan based on a second set of configuration parameters;
automatically calculate execution time of the second query plan;
create a second query object corresponding to the second query plan, wherein the second query object comprises the second query plan and the calculated execution time of the second query plan;
compare a calculated execution time of the first query plan with the calculated execution time of the second query plan;
based on the compared execution times, determine a query plan with a shortest execution time from the first query plan and the second query plan; and
set the determined query plan with the shortest execution time as a current query execution plan.

9. The computer system of claim 8, wherein the actions further comprise:
evaluate a number of possible query plans based on the first set of configuration parameters, wherein an estimated cost is assigned to each of the number of possible query plans;
determine a possible query plan with a lowest estimated cost from the number of possible query plans; and
generate the first query plan from the determined possible query plan.

10. The computer system of claim 8, wherein the actions further comprise:
receive a second request to execute the query, wherein the second request is received before the first request;
determine that the first query plan generated based on the first set of configuration parameters is not present;
generate the first query plan;
automatically calculate the execution time of the first query plan by executing the first query plan in test mode; and
create a first query object corresponding to the first query plan, wherein the first query object comprises the first query plan and the execution time of the first query plan.

11. The computer system of claim 8, wherein the actions further comprise:
execute the second query plan in test mode one or more times;
capture execution times from the one or more executions of the second query plan;
calculate an average sum of the captured execution time of the second query plan; and
automatically calculate the execution time of the second query plan.

12. The computer system of claim 8, wherein the actions further comprise:
receive a third request to execute the query;
determine that the first query plan and the second query plan are present;
generate a third query plan based on a third set of configuration parameters;
automatically calculate execution time of the third query plan;
create a third query object corresponding to the third query plan, wherein the third query object comprises the third query plan and the automatically calculated execution time of the third query plan;
compare the calculated execution time of the third query plan with the calculated execution time of the first query plan and with the calculated execution time of the second query plan; and
based on the compared execution times, determine the current query execution plan.

13. The computer system of claim 12; wherein the actions further comprise:
execute the query in accordance with the current query execution plan, wherein execution time is captured;
calculate an average sum of the captured execution time and the calculated execution time of the current query execution plan;
compare the calculated average sum with the execution times of the first query plan, the second query plan, and the third query plan to determine a new query execution plan with the shortest execution time; and
set the new query execution plan as the current query execution plan.

14. A non-transitory computer readable medium storing instructions, which when executed by at least one processor cause a computer to perform operations comprising:
receive a first request to execute a query;
determine that a first query plan generated based on a first set of configuration parameters is present;
generate a second query plan based on a second set of configuration parameters;
automatically calculate execution time of the second query plan;
create a second query object corresponding to the second query plan, wherein the second query object comprises the second query plan and the calculated execution time of the second query plan;
compare calculated execution time of the first query plan with the calculated execution time of the second query plan;
based on the compared execution times, determine a query plan with a shortest execution time from the first query plan and the second query plan; and
set the determined query plan with the shortest execution time as a current query execution plan.

15. The computer readable medium of claim 14 further comprising:
evaluate a number of possible query plans based on the first set of configuration parameters, wherein an estimated cost is assigned to each of the number of possible query plans;
determine a possible query plan with a lowest estimated cost from the number of possible query plans; and
generate the first query plan from the determined possible query plan.

16. The computer readable medium of claim 14 further comprising:
receive a second request to execute the query, wherein the second request is received before the first request;
determine that the first query plan generated based on the first set of configuration parameters is not present;
generate the first query plan;
automatically calculating the execution time of the first query plan by executing the first query plan in test mode; and
creating a first query object corresponding to the first query plan, wherein the first query object comprises the first query plan and the execution time of the first query plan.

17. The computer readable medium of claim 14, wherein automatically calculate the execution time of the second query plan comprises:
execute the second query plan in test mode one or more times;
capture execution times from the one or more executions of the second query plan; and
calculate an average sum of the captured execution time of the second query plan.

18. The computer readable medium of claim 14 further comprising:
receive a third request to execute the query;
determine that the first query plan and the second query plan are present;
generate a third query plan based on a third set of configuration parameters;
automatically calculate execution time of the third query plan;
create a third query object corresponding to the third query plan, wherein the third query object comprises the third query plan and the automatically calculated execution time of the third query plan;
compare the calculated execution time of the third query plan with the calculated execution time of the first query plan and with the calculated execution time of the second query plan; and
based on the compared execution times, determine the current query execution plan.

19. The computer readable medium of claim 18 further comprising:
execute the query in accordance with the current query execution plan, wherein execution time is captured;
calculate an average sum of the captured execution time and the calculated execution time of the current query execution plan;
compare the calculated average sum with the execution times of the first query plan, the second query plan, and the third query plan to determine a new query execution plan with the shortest execution time; and
set the new query execution plan as the current query execution plan.

20. The computer readable medium of claim 18, wherein automatically calculate the execution time of the third query plan comprises:
execute the third query plan in test mode one or more times;
capture execution times from the one or more executions of the third query plan; and
calculate an average sum of the captured execution times of the third query plan.
